(19) United States
(12) Patent Application Publication
(10) Pub. No.: US 2006/0007957 A1
(43) Pub. Date: Jan. 12, 2006

(54) Transfer of a multimedia message

(75) Inventors: Sisko Pihlajamaki, Tampere (FI); Miraj Mostafa, Tampere (FI); Paivi Vesanto, Tampere (FI); Arja Pietikainen, Pirkkala (FI); Heikki Poikela, Tampere (FI)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(73) Assignee: Nokia Corporation

(21) Appl. No.: 10/867,575

(22) Filed: Jun. 14, 2004

(51) Int. Cl. H04J 3/16

(52) U.S. Cl. 370/471

(57) ABSTRACT

The invention relates to methods of supporting a transfer of a multimedia message. In order to simplify such a transfer, at least one header with information required for the transfer of the multimedia message is specified in an extensible mark-up language structure. In addition, a data content of the multimedia message is specified in an extensible mark-up language structure. The extensible mark-up language structure including the specified header and the specified data content is then provided for a transfer. When such an extensible mark-up language structure is received, the multimedia message is extracted from it. The invention relates equally to modules, to electronic devices, to a system and to software program products supporting such a transfer of a multimedia message.

### FIELD OF THE INVENTION

The invention relates to methods of supporting a transfer of a multimedia message. The invention relates equally to modules, to electronic devices, to systems and to software program products supporting a transfer of a multimedia message.

### BACKGROUND OF THE INVENTION

The multimedia messaging system (MMS) enables user to send and receive multimedia messages (MM), which may comprise message elements of various media types.

For a transmission, multimedia messages can be defined in the form of binary MMS protocol data units (PDUs), as specified for instance in “Wireless Application Protocol WAP-209-MMSEncapsulation-20010601-a”, Version 1 Jun. 2001 by the Wireless Application Protocol Forum, Ltd.

The definition of MMS PDUs is adapted specifically to the needs of transmission of the MMS message over the air interface using a wireless communication network. MMS PDU consists to this end of a message body and in addition of MMS headers comprising all information required for a transmission between a mobile terminal and a server in the wireless communication network, which provides access to various messaging systems. The header fields are partly optional, but partly as well mandatory, like Message-Type, Transaction-ID, MMS-version, etc. Further, the MMS PDUs have to be binary encoded according to specified encoding rules.

The requirement to define such an MMS PDU renders a transfer of multimedia messages impractical in some situations which do not involve a transmission over a wireless communication network.

For example, the operator of a mobile communication network may want to define some multimedia messages, which are included in mobile terminals already in the factory producing the mobile terminals. To this end, the operator has to transfer the multimedia messages to the MMS engine of a respective mobile terminal. The operator may not have a suitable program to produce binary MMS PDU files including all mandatory headers, though.

Further, it might be desirable that some applications, for instance some Java applications, are able to use multimedia messages as a carrier for transferring data to an MMS engine of a mobile terminal. However, an application will usually not know all headers, which are required for a full MMS PDU in binary format. For example, neither the PDU-type, the Transaction ID nor the MMS version might be of interest or known to the application.

Besides the binary MMS PDUs, there is no standard solution for defining a multimedia message. In practice, some MMS servers use the Multipurpose Internet Mail Extension (MIME) format for internal transfers of multimedia messages. It is a disadvantage of the MIME format, though, that it is quite tedious to parse. It also has severe limitations as to the character sets which can be employed and the presentation of binary data. The binary data must be base-64 encoded to be representable in a 7-bit format.

### SUMMARY OF THE INVENTION

An object of the invention is to simplify the transfer of multimedia messages. In particular, an object of the invention is to simplify the transfer of multimedia messages in those cases, which multimedia messages are not to be transmitted between a mobile communication terminal and an MMSC.

A first method of supporting a transfer of a multimedia message is proposed, which comprises specifying at least one header with information required for the transfer of the multimedia message in an extensible mark-up language structure. The method further comprises specifying a data content of the multimedia message in the extensible mark-up language structure. The method further comprises providing the extensible mark-up language structure including the specified header and the specified data content for a transfer.

A second method of supporting a transfer of a multimedia message is proposed, which comprises receiving an extensible mark-up language structure, and extracting a multimedia message from this received extensible mark-up language structure.

Moreover, a specification module supporting a transfer of a multimedia message is proposed. The specification module is adapted to specify at least one header with information required for a transfer of a multimedia message in an extensible mark-up language structure. The specification module is further adapted to specify a data content of a multimedia message in an extensible mark-up language structure. The specification module is further adapted to provide an extensible mark-up language structure including a specified header and a specified data content for a transfer. The specification module can be for example an MMS engine or an application.

Moreover, an electronic device is proposed, which comprises such a specification module. The electronic device can be for example a mobile communication terminal or a personal computer (PC).

Moreover, an extraction module supporting a transfer of a multimedia message is proposed. The extraction module is adapted to extract a multimedia message from a received extensible mark-up language structure. The extraction module can be for example an MMS engine or an application.

Moreover, an electronic device is proposed, which comprises such an extraction module. The electronic device can be for example a mobile communication terminal or a PC.

Moreover, a system is proposed, which comprises the proposed specification module and/or the proposed extraction module.

Finally, software program products are proposed, in which a respective software code for supporting a transfer of a multimedia message is stored. When running in a processing unit of an electronic device, the software code of a first software program product realizes the first proposed method. When running in a processing unit of an electronic device, the software code of a second software program product realizes the second proposed method.

The invention proceeds from the consideration that an extensible mark-up language like XML is a generic language that can be adapted to specify any information in a structured manner. XML, for instance, does not specify any tags or semantics. It rather provides an option to define tags and the structural relationship between them. All of the semantics of an XML document can be defined by the applications that process the XML document or by stylesheets to which applications have access. An extensible mark-up language is thus well suited to specify data, which is to be transferred in a flexible way.

It is therefore proposed that in certain cases, an extensible mark-up language structure is used instead of an MMS PDU for specifying headers and data content for a multimedia message.

It is an advantage of the invention that it simplifies the transfer of multimedia messages in those cases in which the use of MMS PDUs is not required. On the one hand, the construction and processing of an extensible mark-up language structure is easier than the construction and processing of a binary MMS PDU. On the other hand, the number of headers and in particular the number of mandatory headers can be reduced when avoiding the use of MMS PDUs. Thus, information, which is relevant in the context of multimedia transmissions over the air interface between a mobile communication terminal and an MMSC, does not have to be dealt with in other kinds of transfers. For example, error codes or requests for delivery reports, PDU type or transaction ID can be left out in the data, which is transferred.

The extensible mark-up language, which is employed in accordance with the invention, can be in particular XML, but equally any other extensible mark-up language, like the Synchronization Markup Language (SyncML). Compared to MIME, XML has the advantage that it is more flexible. XML allows the use of the Unicode Transformation Format-8 (utf-8) as a character set so that a separate encoding of all non-us-ascii header files is not required.

In one embodiment of the invention, the extensible mark-up language structure defines headers for any information, which might be of interest for an application. Such headers may comprise for example information on a subject of the multimedia message, information on at least one media type comprised in the multimedia message, information on a sender of the multimedia message, information on at least one recipient of the multimedia message, information on an expiry date of the multimedia message, etc. With such a general definition, a single extensible mark-up language structure can be used in various situations.

Applications, like Java application, for which a multimedia message is to be used as a transport means, could have a unique identification. A new multimedia message header could carry the identification of the application for which a multimedia message is intended. By evaluating the new multimedia message header, an MMS engine of a mobile communication device may then forward a respective multimedia message to the correct application. For such a situation, the header comprising the application identification is advantageously specified as well in the proposed extensible mark-up language structure beside other information, when the extensible mark-up language structure is to be used in either direction for a communication between an MMS engine and an application.

In a further embodiment of the invention, the extensible mark-up language structure defines only optional headers. As a result, only the headers have to be specified which are relevant in the particular situation. For example, only those headers which are relevant for a transfer or only those headers which are of interest for an application to which the multimedia message is to be transferred have to be specified.

In one embodiment of the invention, the extensible mark-up language structure is defined to comprise character set information. In this case, the extensible mark-up language structure in addition advantageously allows including or attaching binary files for specifying a data content of the multimedia message. This ensures that the data content of a multimedia message can be used without a conversion to a 7-bit format.

Alternatively, the extensible mark-up language format can be defined to comprise binary information. Binary XML might be easier to implement in certain cases.

A binary extensible mark-up language and a non-binary extensible mark-up language can be defined in an equivalent manner.

The invention can be employed for instance for transmitting data using a multimedia message as carrier in either direction between an MMS engine and an application, in particular an application which is external to the device comprising the MMS engine.

The invention can be employed, for example, for synchronizing multimedia messages between a personal computer and a mobile communication device. In this case, SyncML could be used as an extensible mark-up language. The invention can further be employed, for example, for creating a multimedia message on a personal computer and for transferring the created multimedia message to a mobile communication device for transmitting it to some other mobile communication device.

The invention can equally be employed, for example, for enabling an operator of a mobile communication network to cause a transfer of multimedia messages to a mobile communication device already at a production site in an easy way. The operator could send multimedia messages as extensible mark-up language files to a manufacturer by any means not involving the actual mobile communication device, for example by means of an email or a floppy disk. The manufacturer can then include these files into an image, which is to be flashed to a memory of the mobile communication device at the factory. Alternatively, the manufacturer could put the extensible mark-up language file onto a removable memory card, which can be inserted later on to a mobile communication device for further use.

The invention can equally be employed, for example, for transferring multimedia messages between mobile communication terminals.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not drawn to scale and that they are merely intended to conceptually illustrate the structures and procedures described herein.

### BRIEF DESCRIPTION OF THE FIGURES

FIG. 1 is a schematic block diagram of systems according to embodiments of the invention;

FIG. 2 is a flow chart illustrating the transfer of multimedia messages in a first system of FIG. 1; and

FIG. 3 is a flow chart illustrating the transfer of multimedia messages in a second system of FIG. 1.

### DETAILED DESCRIPTION OF THE INVENTION

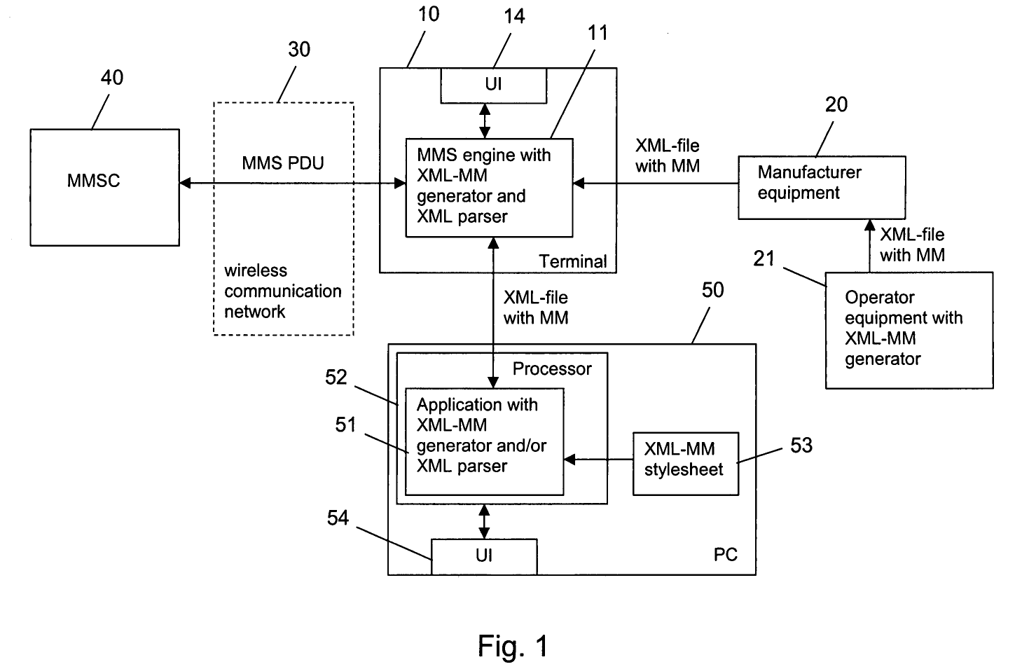

FIG. 1 schematically presents two systems according to embodiments of the invention, which enable a simplified transfer of multimedia messages using XML.

Both systems comprise a mobile terminal 10, which may interact with a variety of other devices. During or after its production in a factory, the mobile terminal 10 may interact with manufacturer equipment 20. Further, it may interact via wireless communication network 30 with MMSC 40. Moreover, it may interact with a PC 50.

The first system comprises in addition to the mobile terminal 10 at least the manufacturer equipment 20 and operator equipment 21. The second system comprises in addition to the mobile terminal 10 at least the PC 50.

The mobile terminal 10 includes MMS engine 11 and a user interface UI 14. The MMS engine 11 is designed to realize conventional functions of an MMS engine 11. The MMS engine 11 thus handles the storage of a message in an internal format, which is suitable for the operating system installed in the mobile terminal 10. Moreover, it provides an application programming interface (API) for accessing the message parts. MMS UI component of the user interface UI 14 calls this API, when a user views or composes a multimedia message. The MMS engine 11 also takes care of encoding and decoding of messages from the internal format to the binary MMS encapsulation format, and vice versa, which is used for transferring MMS messages in MMS PDUs over the air interface. The MMS engine 11 uses an appropriate protocol for sending and receiving MMS messages over the air and for receiving MMS notifications and delivery reports pushed via SMS to the mobile terminal 10 from the MMSC 40. In addition, the MMS engine 11 comprises an XML multimedia message generator and an XML parser.

The operator equipment 21 includes an XML multimedia message generator. The manufacturer equipment 20 is adapted to receive XML files comprising multimedia messages from the operator equipment 21.

The PC 50 comprises at least one application 51 which can be run by a processor 52 of the PC 50. The application realizes as well XML MMS message generator and/or XML parser, and it has access to XML-MM stylesheet 53.

For exchanging multimedia messages between the terminal 10 and the MMSC 40, the multimedia messages are encapsulated in a conventional manner in MMS PDUs.

For exchanging MMS messages between the terminal 10 and the manufacturer equipment 20, or between the terminal 10 and the PC 50, however, the use of MMS PDUs may not be appropriate. Therefore, an XML file is used in these cases for transferring a multimedia message.

To this end, the mobile terminal 10, the operator equipment 21 and the PC 50 all have access to an XML definition. The XML definition may be stored for instance in an XML stylesheet defined specifically for multimedia messages. For the PC 50, such a stylesheet 53 is depicted as a separate component. The reason for this presentation is that if the stylesheet 53 is not integrated in the application 51 but stored separately, it may be accessed by different applications run by the processor 52.

The XML definition includes tags for all headers, which might be of relevance for the transfer of a multimedia message, and tags for the data content of a multimedia message. All headers are optional, so that a device may specify only those headers that are relevant in the particular situation.

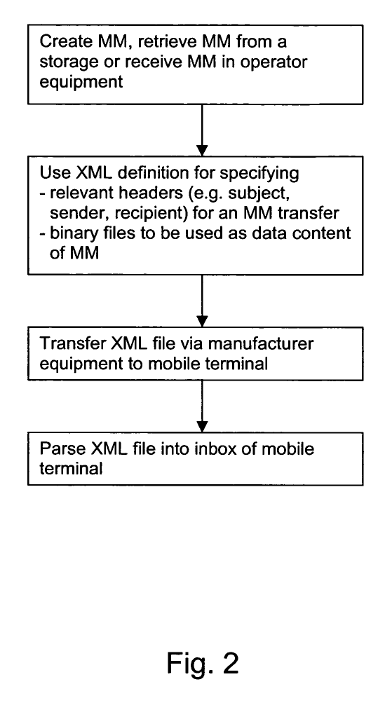

The transfer of a multimedia message by means of XML file from the operator equipment 21 to the mobile terminal 10 will now be explained with reference to the flow chart of FIG. 2.

An operator might wish to supply the mobile terminal 10 with a particular multimedia message already at a production site.

The operator equipment 20 then creates the multimedia message, receives the multimedia message from some other device or retrieves the multimedia message from a storage portion. The multimedia message may contain a SMIL presentation part which defines how the message parts should be defined, but the SMIL part does not contain tags for header information.

Then, the XML multimedia message generator of the operator equipment 20 uses the predetermined XML definition for generating a binary XML structure. Based on the available XML definition, the XML multimedia message generator specifies all relevant headers for the multimedia message. Further, it specifies the binary files, which are to be used as data content of the message. It should be noted that the XML multimedia message generator is or forms part of an application, which is run in the operator equipment 20.

Next, the operator equipment 21 transfers the created XML structure as an XML file to the manufacturer equipment 20, for instance by means of an email attachment or by means of a floppy disk or the like.

The manufacturer equipment 20 includes the received XML file in an image, which is flashed to a memory of the mobile terminal 10.

When the mobile terminal 10 is ready to be used and is booted for the first time, the XML file containing the multimedia message is parsed by the MMS engine 11 into an inbox, or to some other place where the multimedia message is accessible to a user via the user interface 14 for further use.

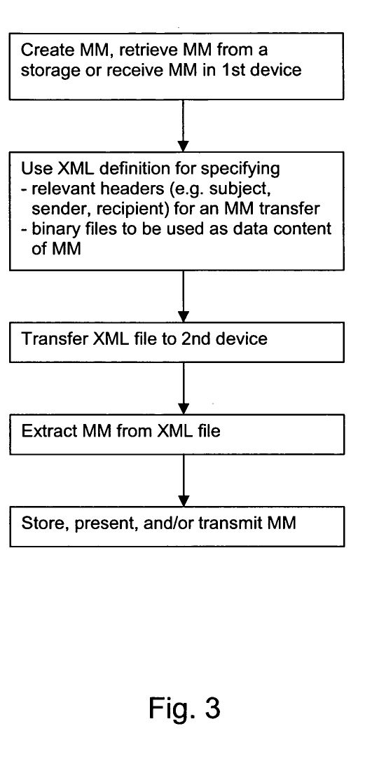

The transfer of a multimedia message by means of an XML file between the mobile terminal 10 and the PC 50 will now be explained for two different situations with reference to the flow chart of FIG. 3.

In a first situation, the multimedia message is to be transmitted from the PC 50 as a first device to the mobile terminal 10 as a second device.

The processor 52 of the PC 50 runs an application 51, for example a Java application, which might want to use a multimedia message as a carrier for sending some data to the mobile terminal 10. The application 51 creates therefore a multimedia message in which the data is included. Next, the application 51 makes use of the XML stylesheet 53 for creating an XML structure. The XML definition in the stylesheet 53 defines that the XML structure is to contain character set information. In addition, the XML definition allows attaching binary files to the XML structure without a conversion to a 7-bit format. In the XML structure, the application specifies headers, which are relevant for the multimedia message transfer, and the data content of the multimedia message in the form of binary files. As character set, utf-8 is used so that a separate encoding of all non-us-ascii header files is not required.

The created XML structure is then transferred as an XML file to the mobile terminal 10, taking into account the header information in the XML structure. In the mobile terminal 10, the MMS engine 11 uses the included XML parser for extracting the multimedia message from the received XML file. In the mobile terminal 10, the binary XML structure used by the operator equipment 20 and the XML structure used by the PC 5O are defined to be equivalent.

The extracted multimedia message can then be presented to a user via the user interface 14 of the mobile terminal 10. Alternatively or in addition, the multimedia message can be stored. Further alternatively, the multimedia message can be transmitted via the wireless communication network 30 to some other mobile terminal using MMS PDU.

In the second situation, a multimedia message is to be transmitted from the mobile terminal 10 as a first device to the PC 50 as a second device.

The mobile terminal 10 may receive a multimedia message from the MMSC 40 or retrieve a multimedia message from a storage portion. Moreover, a user of the mobile terminal 10 may create a multimedia message using the user interface 14. The user of the mobile terminal 10 may then desire to transfer the available multimedia message to the PC 50, for instance to make use of better presentation capabilities of the PC 50.

Upon request by the user via the user interface 14, the XML generator included in the MMS engine 11 generates XML structure comprising the available multimedia message based on the available XML definition. The XML definition defines that the XML structure is to contain character set information. In addition, the XML definition again allows attaching binary files to the XML structure without conversion to a 7-bit format. The generated XML structure specifies headers, which are relevant for the multimedia message transfer, and in addition the data content of the multimedia message in the form of binary files, as character set, utf-8 is used.

The created XML structure is then transferred as an XML file to the PC 50, taking into account the header information in the XML structure. In the PC 50, an application 51 run by the processor 52 applies an XML parser for extracting the multimedia message from the received XML file, making use of the XML stylesheet 53.

The multimedia message can now be stored in the PC 50 or presented to a user via the user interface 54 of the PC 50.

While there have been shown and described and pointed out fundamental novel features of the invention as applied to a preferred embodiment thereof, it will be understood that various omissions and substitutions and changes in the form and details of the devices and methods described may be made by those skilled in the art without departing from the spirit of the invention. For example, it is expressly intended, that all combinations of those elements and/or method steps that perform substantially the same function in substantially the same way to achieve the same results, are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A method of supporting a transfer of a multimedia message, said method comprising:
specifying at least one header with information required for said transfer of said multimedia message in an extensible mark-up language structure;
specifying a data content of said multimedia message in an extensible mark-up language structure; and
providing said extensible mark-up language structure including said specified header and said specified data content for a transfer.

2. The method according to claim 1, wherein said extensible mark-up language structure is defined to comprise optional headers.

3. The method according to claim 1, wherein said extensible mark-up language structure comprises headers for information on at least one of the following:
a subject of said multimedia message;
at least one media type comprised in said multimedia message;
a sender of said multimedia message;
at least one recipient of said multimedia message; and
an expiry date of said multimedia message.

4. The method according to claim 1, wherein said extensible mark-up language structure is defined to comprise character set information.

5. The method according to claim 1, wherein said extensible mark-up language structure is defined to allow at least one of an inclusion and an attachment of binary files for specifying a data content of said multimedia message.

6. The method according to claim 1, wherein said extensible mark-up language structure is defined to comprise binary information.

7. The method according to claim 1, wherein said extensible mark-up language structure is transferred from an application to a multimedia messaging service engine.

8. The method according to claim 1, wherein said extensible mark-up language structure is transferred from a multimedia messaging service engine to an application.

9. The method according to claim 1, wherein said extensible mark-up language structure is created in a first device and transferred to a second device.

10. A method of supporting a transfer of a multimedia message, said method comprising:
receiving an extensible mark-up language structure;
and
extracting a multimedia message from said received extensible mark-up language structure.

11. A specification module supporting a transfer of a multimedia message,
wherein said specification module is adapted to specify at least one header with information required for a transfer of a multimedia message in an extensible mark-up language structure;
wherein said specification module is adapted to specify a data content of a multimedia message in an extensible mark-up language structure; and
wherein said specification module is adapted to provide an extensible mark-up language structure including a specified header and a specified data content for a transfer.

12. The specification module according to claim 11, wherein said specification module is a multimedia messaging service engine.

13. The specification module according to claim 11, wherein said specification module is an application.

14. An electronic device supporting a transfer of a multimedia message, said electronic device comprising a specification module,
wherein said specification module is adapted to specify at least one header with information required for a transfer of a multimedia message in an extensible mark-up language structure;
wherein said specification module is adapted to specify a data content of a multimedia message in an extensible mark-up language structure; and
wherein said specification module is adapted to provide an extensible mark-up language structure including a specified header and a specified data content for a transfer.

15. The electronic device according to claim 14, wherein said electronic device is a mobile communication terminal and wherein said specification module is at least one of a multimedia messaging service engine and an application.

16. The electronic device according to claim 14, wherein said electronic device is a personal computer and wherein said specification module is an application.

17. An extraction module supporting a transfer of a multimedia message,
wherein said extraction module is adapted to extract a multimedia message from a received extensible mark-up language structure.

18. The extraction module according to claim 17, wherein said specification module is a multimedia messaging service engine.

19. The extraction module according to claim 17, wherein said specification module is an application.

20. An electronic device supporting a transfer of a multimedia message, said electronic device comprising an extraction module,
wherein said extraction module is adapted to extract a multimedia message from a received extensible mark-up language structure.

21. The electronic device according to claim 20, wherein said extraction module is a multimedia messaging service engine.

22. The electronic device according to claim 20, wherein said extraction module is an application.

23. A system supporting a transfer of a multimedia message, said system comprising a specification module,
wherein said specification module is adapted to specify at least one header with information required for a transfer of a multimedia message in an extensible mark-up language structure;
wherein said specification module is adapted to specify a data content of a multimedia message in an extensible mark-up language structure; and
wherein said specification module is adapted provide an extensible mark-up language structure including a specified header and a specified data content for a transfer to said extraction module.

24. The system according to claim 23, said system further comprising an extraction module, wherein said extraction module is adapted to extract a multimedia message from an extensible mark-up language structure received from said specification component.

25. The system according to claim 24, wherein said specification module is part of a first electronic device and wherein said extraction module is part of a second electronic device.

26. The system according to claim 25, wherein said first electronic device is a mobile communication terminal, wherein said specification module is at least one of a multimedia messaging service engine and an application, wherein said second electronic device is a personal computer and wherein said extraction module is an application.

27. The system according to claim 25, wherein said first electronic device is a personal computer, wherein said specification module is an application, wherein said second electronic device is a mobile communication terminal and wherein said extraction module is at least one of a multimedia messaging service engine and an application.

28. The system according to claim 25, wherein said first electronic device is a mobile communication terminal, wherein said specification module is at least one of a multimedia messaging service engine and an application, wherein said second electronic device is a mobile communication terminal and wherein said extraction module is at least one of a multimedia messaging service engine and an application.

29. A system supporting a transfer of a multimedia message, said system comprising an extraction module, wherein said extraction module is adapted to extract a multimedia message from a received extensible mark-up language structure.

30. A software program product in which a software code for supporting a transfer of a multimedia message is stored, said software code realizing the following steps when running in a processing unit of an electronic device:
specifying at least one header with information required for said transfer of said multimedia message in an extensible mark-up language structure;
specifying a data content of said multimedia message in an extensible mark-up language structure; and
providing said extensible mark-up language structure including said specified header and said specified data content for a transfer.

31. A software program product in which a software code for supporting a transfer of a multimedia message is stored, said software code realizing the following steps when running in a processing unit of an electronic device:
receiving an extensible mark-up language structure; and
extracting a multimedia message from said received extensible mark-up language structure.
